(19) United States
(12) Patent Application Publication
(10) Pub. No.: US 2003/0108218 A1
(43) Pub. Date: Jun. 12, 2003

(54) Spring suspension speaker

(76) Inventor: Hsien Chung Lan, Arcadia, CA (US)

Correspondence Address: JOE NIEH, 17800 CASTLETON STREET, SUITE 475, CITY OF INDUSTRY, CA, 91748, US

(21) Appl. No.: 10/010,013

(22) Filed: Dec. 6, 2001

(51) Int. Cl. H04R 1/00; H04R 9/06

(52) U.S. Cl. 381/398; 381/405

(57) ABSTRACT

The present invention is a spring suspension speaker that will virtually eliminate failure of the speaker due to fatigue from cyclic stress from regular use of the speaker or due to a surge of power to the speaker. The present invention comprises of a flexible support member installed within the conventional speaker. The present invention improves the performance and the life expectancy of the conventional speaker and also improves the responsiveness of the speaker, thereby increase the accuracy of the sound reproduced by the speaker.

### BACKGROUND—FIELD OF INVENTION

The present invention relates to speakers used to reproduce sounds such as voice and music.

### BACKGROUND—DESCRIPTION OF RELATED ART

Conventional speakers used to reproduce sounds such as voice and music generally comprises of a back plate and a front plate enclosing a permanent magnet. A voice coil is affixed to the top of the back plate and the cone is attached to the top of the voice coil. The spider is attached between the bottom of the cone and the basket, which surrounds the cone. A dustcap covers the opening formed by the cone and a surround is attached between the dustcap and the circular gasket around the dustcap. The cone is thereby supported by both the spider and the surround.

When electrical current is applied to the terminals on the speaker, the voice coil would move in a linear fashion due to the attraction and repulsion between the electromagnet formed by the electrical current and the permanent magnet located between the back plate and the front plate. The movement of the voice coil will move the cone attached to it, which causes the air in front of the speaker to be compressed or decompressed. This compression and decompression of the air forms the sound waves that can be detected by the human ear as sounds. The sounds produced thereby may be voice, music, or any other sounds.

After a period of use, the spider and the surround in the conventional speaker will fail due to fatigue from the cyclic stress or a surge of power to the speaker. When the spider or the surround fails, the voice coil will be burned out and the speaker becomes unusable and must be replaced.

### SUMMARY OF THE INVENTION

The present invention is a spring suspension speaker that will virtually prevent failure of the speaker due to fatigue from cyclic stress or due to a surge of power to the speaker. The present invention comprises of a flexible support member installed within the conventional speaker. The present invention improves the performance and the life expectancy of the conventional speaker and also improves the responsiveness of the speaker, thereby increase the accuracy of the sound reproduced by the speaker.

### BRIEF DESCRIPTION OF THE DRAWINGS

FIG. 1 shows the cross-sectional view of the present invention.

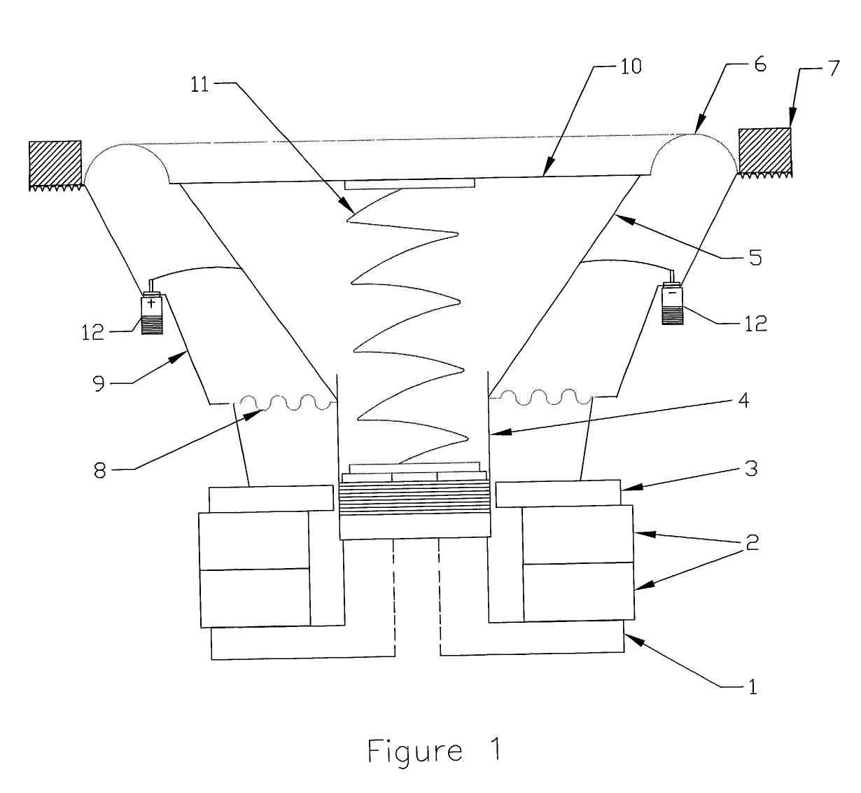

### DETAILED DESCRIPTION OF THE PREFERRED EMBODIMENT

In the preferred embodiment of the present invention, a spring 11 is installed within the conventional speaker to virtually prevent failure of the speaker due to fatigue from cyclic stress or due to a surge of power to the speaker. Furthermore, the present invention improves the performance and the life expectancy of the conventional speaker and also improves the responsiveness of the speaker, thereby increase the accuracy of the sound reproduced by the speaker.

The conventional speaker comprises of a circular back plate 1 and a circular front plate 3 with a permanent magnet 2 between them. A voice coil 4 is attached to the top of the back plate 1. A cone 5 is attached to the top of the voice coil 4. The cone 5 is supported on the top by a surround 6 that is affixed to the cone 5 on one side and to the gasket 7 on the other side. The cone 5 is supported on the bottom by a spider 8 that is attached to the basket 9, which surrounds the cone 5. A dustcap 10 covers the opening at the top of the cone 5.

When electrical current is applied to the terminals 12 on the speaker, the voice coil 4 will be energized and becomes an electro magnet. The electro magnet would interact with the permanent magnet 2 and move in a reciprocating linear fashion due to the repulsion and attraction between the magnets. The movement of the voice coil 4 will cause the cone 5 to move in the same fashion thereby causing compression and decompression of the air in front of the speaker. This compressions and decompression of the air is detected by the human ear as sound.

In the preferred embodiment of the present invention, a spring 11 is installed between the back plate 1 and the dustcap 10. The spring 11 will greatly reduce the stress on the spider 8 and the surround 6 and virtually eliminate failure due to fatigue from the cyclic stress or a surge of power to the speaker. The present invention will improve the performance and the life expectancy of the conventional speaker and also improves the responsiveness of the speaker, thereby increase the accuracy of the sound reproduced by the speaker.

In yet another embodiment of the present invention, the spring 11 is installed between the basket 9 and the cone 5 to provide support to the cone 5.

Another embodiment of the present invention may utilize an air pump/air spring in place of the spring 11 to provide support to the cone 5.

What is claimed is:

1. A spring suspension speaker comprising:
a back plate with a raised axle;
a permanent magnet mounted on top of the back plate around the raised axle;
a front plate enclosing the permanent magnet around the raised axle;
a voice coil attached to the top of the raised axle;
a terminal electrically connected to the voice coil;
a cone with a top and bottom attached to the top of the voice coil;
a surround attached to the top of the cone on one side and attached to a gasket on the other side;
a spider attached to the bottom of the cone on one side and to a basket on the other side;
a dustcap covering the top of the cone; and
a flexible support member supporting the cone;
wherein the flexible support member will greatly reduce the stress on the spider and the surround by providing additional support to the cone.

2. A spring suspension speaker according to claim 1, wherein said flexible support member is a spring placed between the back plate and the dustcap.

3. A spring suspension speaker according to claim 1, wherein said flexible support member is an air pump placed between the back plate and the dustcap.

4. A spring suspension speaker according to claim 1, wherein said flexible support member is a spring between the basket and the cone.

5. A spring suspension speaker according to claim 1, wherein said flexible support member is an air pump placed between the basket and the cone.

6. A spring suspension speaker comprising a speaker and a flexible support member, wherein the improvement comprises of inserting a flexible support member to support the cone.

7. A spring suspension speaker according to claim 6, wherein said flexible support member is a spring inserted between the backplate and the dust cap of the speaker.

8. A spring suspension speaker according to claim 6, wherein said flexible support member is an air pump inserted between the backplate and the dust cap of the speaker.

9. A spring suspension speaker according to claim 6, wherein said flexible support member is a spring between the basket and the cone.

10. A spring suspension speaker according to claim 6, wherein said flexible support member is an air pump placed between the basket and the cone.
